(19) United States
(12) Patent Application Publication
(10) Pub. No.: US 2010/0200716 A1
(43) Pub. Date: Aug. 12, 2010

(54) MODULAR RACK FOR ELECTRONIC SYSTEMS

(75) Inventor: Charles E. White, III, Raleigh, NC (US)

Correspondence Address: STREETS & STEELE - IBM CORPORATION, 13100 WORTHAM CENTER DRIVE, SUITE 245, HOUSTON, TX, 77065, US

(73) Assignee: INTERNATIONAL BUSINESS MACHINES CORPORATION, Armonk, NY (US)

(21) Appl. No.: 12/367,782

(22) Filed: Feb. 9, 2009

(51) Int. Cl. A47B 96/06; B23P 19/04

(52) U.S. Cl. 248/243; 29/238

(57) ABSTRACT

One embodiment of the invention provides a rack assembly for a rack-mount system, such as a 19-inch rack. A plurality of vertical rack supports each have first and second rails joined at an angle. The first rail defines a plurality of vertically-spaced holes. A bracket includes a bracket body, a pivot arm projecting from the bracket body, a pivot member coupled to the pivot arm and having a pivot axis orthogonal to the pivot arm, a bracket-retention flange projecting from the bracket body and radially spaced in a radial direction from the pivot member, and a shelf-support flange projecting from the bracket body and spaced in the same radial direction from the pivot member and at least the same distance from the pivot member as the bracket-retention flange. The shelf-support flange and bracket-retention flange project in opposing directions transverse to the radial direction. The pivot member of the bracket is removably insertable into one of the vertically-spaced holes with the bracket in a first angular position and pivotable about the pivot axis to a second angular position wherein the first rail is captured between the pivot arm and the bracket-retention flange.

### BACKGROUND OF THE INVENTION

1. Field of the Invention

The present invention relates to rack-mount electronic systems, and more specifically to rack components and systems used to support rack-mount components.

2. Background of the Related Art

A 19-inch rack is a standardized system for mounting various electronic components 19 inches (480 mm) wide. Equipment designed to be mounted in a rack is, appropriately, referred to as “rack-mount” equipment. The term “rack mount system” commonly describes a rack having a plurality of interconnected rack-mount components. Depending on the system, rack-mount components may be interconnected and supported directly on shelves of the rack, or within a rack-mount component chassis that holds one or more components.

A typical rack system allows for mounting electronic components of various sizes in a common rack. The electronic components may be specifically arranged within any given rack without requiring alteration of the rack. Rails or tracks on vertically-oriented supports have closely spaced features, such as holes, for coupling chassis, rails, or shelves at any of a large number of vertical increments. In this manner, the space within the rack is utilized efficiently with little or no wasted space.

Special tools are often required to assemble shelves or other mounting hardware used to support the equipment on a rack. For example, components may be secured to the rack with screws along the front and back of the rack. However, a large number of components may be installed in a rack and move from time to time, such that the process of securing components in a rack can become very time consuming. Alternatively, “tool-less” mounting hardware allows a component to be secured to the rack without tools. Still, such “tool-less” mounting hardware tends to be costly and complicated or require a special rack.

### BRIEF SUMMARY OF THE INVENTION

One embodiment of the present invention provides a rack assembly including a plurality of vertical rack supports and a bracket for each vertical support. Each vertical rack support has first and second rails joined at an angle. The first rail defines a plurality of vertically-spaced holes. Each bracket includes a bracket body, a pivot arm projecting from the bracket body, a pivot member coupled to the pivot arm and having a pivot axis orthogonal to the pivot arm, a bracket-retention flange projecting from the bracket body and radially spaced in a radial direction from the pivot member, and a shelf-support flange projecting from the bracket body and spaced in the same radial direction from the pivot member and at least the same distance from the pivot member as the bracket-retention flange. Thus, the pivot member of the bracket is removably insertable into one of the vertically-spaced holes with the bracket in a first angular position and is pivotable about the pivot axis to a second angular position where the first rail is captured between the pivot arm and the bracket-retention flange.

### BRIEF DESCRIPTION OF THE SEVERAL VIEWS OF THE DRAWINGS

FIG. 1 is a perspective view of an example embodiment of a rack assembly according to the invention.

FIG. 2 is a front perspective view of one of the brackets of FIG. 1 in closer detail.

FIG. 3A is a rear elevation view of the bracket.

FIG. 3B is a front elevation view of the bracket.

FIG. 4A is a perspective view of the bracket of FIG. 2 prior to securing the bracket to the vertical support.

FIG. 4B is a perspective view of the bracket with the pivot member inserted into a selected hole on the vertical support.

FIG. 4C is a perspective view of the bracket being pivoted clockwise about the pivot to a locked position to releasably secure the bracket to the vertical support.

FIG. 4D is a perspective view of the bracket in a locked position shown from the opposite side from FIG. 4C.

FIG. 5A is a perspective view of a shelf being lowered onto the previously installed mounting brackets.

FIG. 5B is a perspective view of the shelf having been slid in the direction indicated in FIG. 5A to lock the shelf to the rack.

FIG. 6 is a perspective view of another example embodiment of the invention wherein brackets are provided at the ends of an adjustable-length “telescoping” horizontal support beam.

### DETAILED DESCRIPTION OF THE INVENTION

One embodiment of the invention provides a bracket that may be used to support computer equipment on an industry-standard equipment rack. A plurality of the brackets may be secured to vertical supports of the equipment rack at various heights. Each bracket may be easily secured to one of the vertical supports using an “insert-and-rotate” motion, without the use of tools. The brackets may then be used to support shelves or a rack-mount component chassis, with servers and other equipment supported thereon. The brackets may be inexpensively formed from a unitary piece of material to create a cost-competitive and reliable solution for supporting rack-mount equipment on a rack.

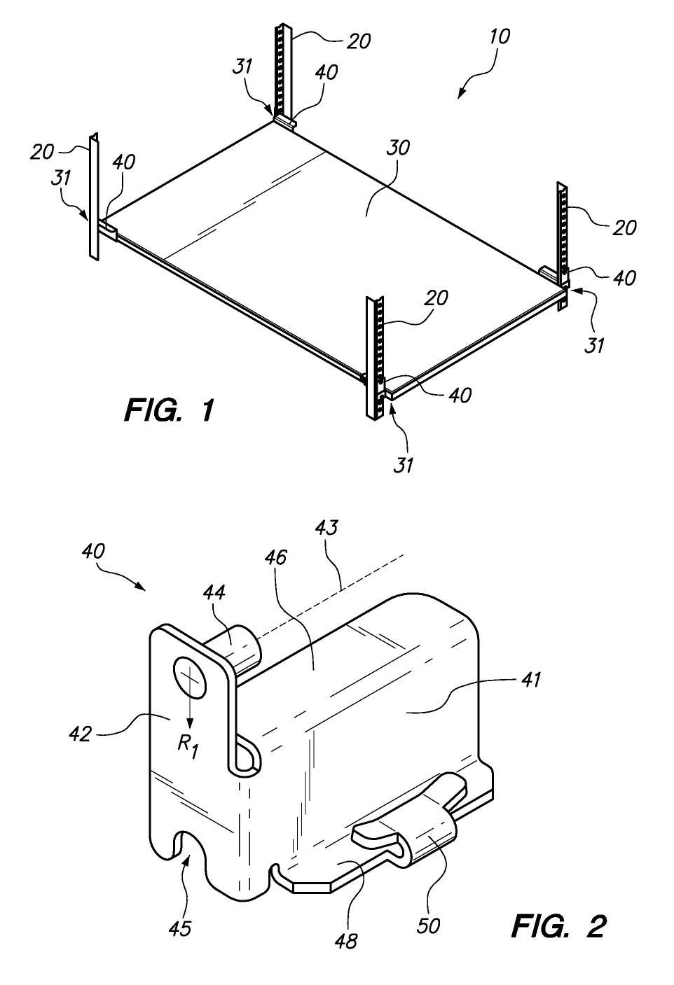

FIG. 1 is a perspective view of an example embodiment of a rack assembly according to the invention. The rack 10 includes four vertical supports 20, four brackets 40 each supported on a respective one of the vertical supports 20, and a shelf 30 horizontally supported on the four brackets 40. Each bracket 40 is removably secured to the respective vertical support 20 at a selected vertical height, as will be further described below. The shelf 30 is supported on the brackets 40 at or near each corner 31, to provide stability to the shelf 30. Typically, the four brackets 40 are positioned at the same height, so that the shelf 30 is level for properly supporting one or more electronic components. Additional shelves (not shown) may be supported at other vertical positions using additional brackets. Rack-mount equipment such as servers may be placed on the shelves and interconnected as a rack-mount electronic system.

FIG. 2 is a front perspective view of one of the brackets 40 in closer detail. The bracket 40 includes a bracket body 41, a pivot arm 42 projecting from the bracket body 41, a pivot member 44 projecting from the pivot arm 42, a bracket-retention flange 46 projecting from the bracket body 41, and a shelf-support flange 48 projecting from the bracket body 41. The pivot member 44 is embodied here as a cylindrical post defining a pivot axis 43 orthogonal to the pivot arm 42. An opening 45 is provided on the bracket 40, radially spaced in the direction R1 from the pivot member 44. A shelf-support tab 50 is optionally provided on the shelf-support flange 48.

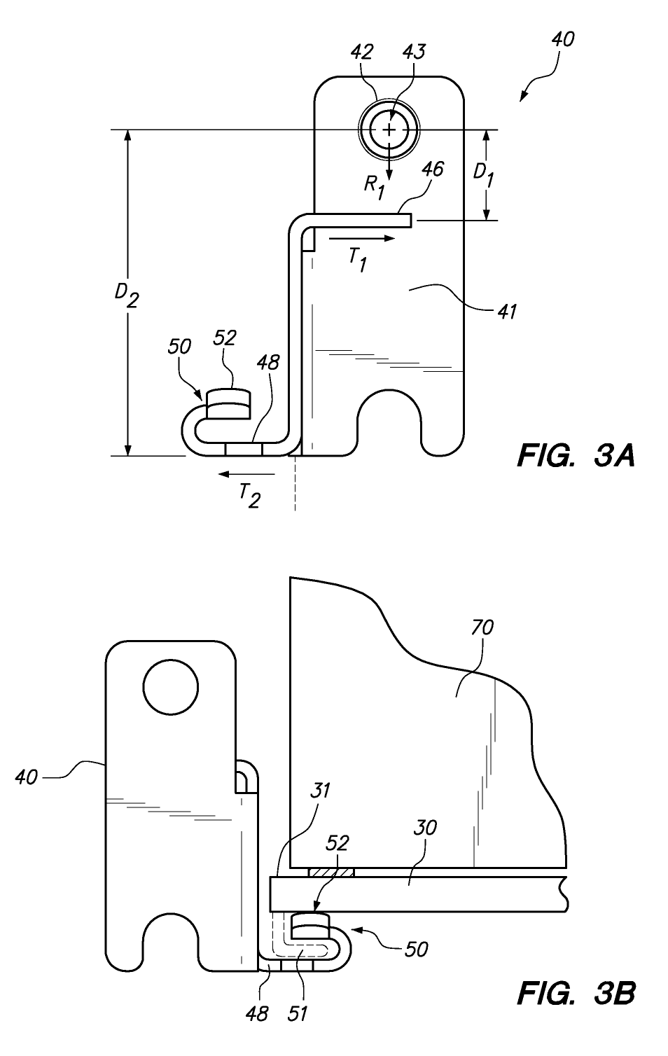

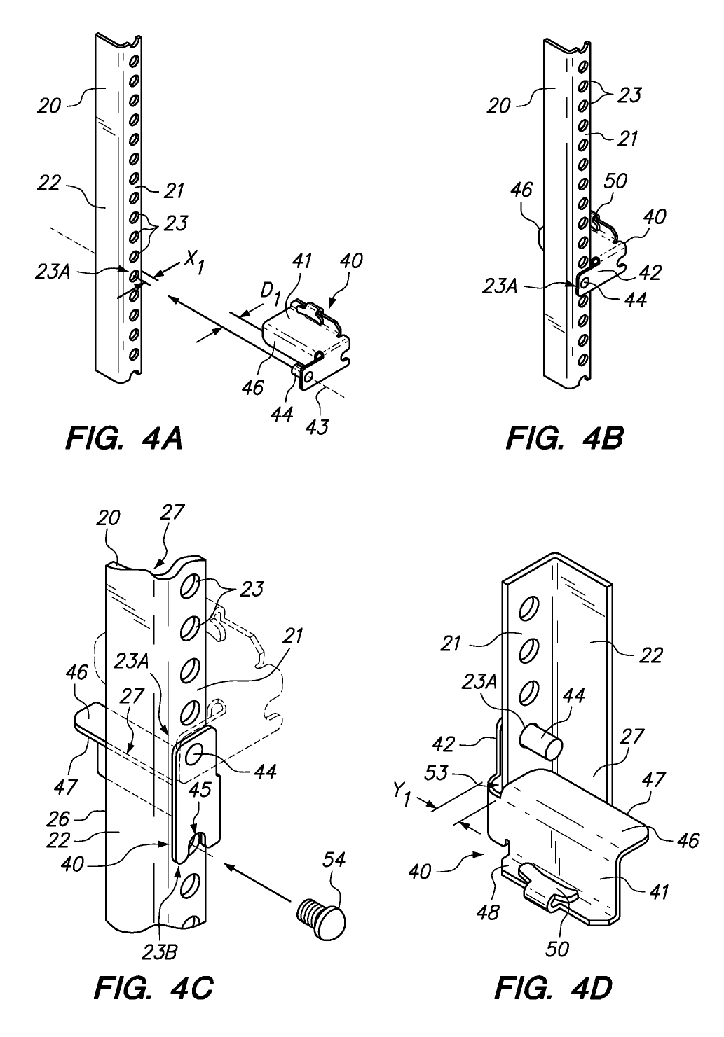

FIG. 3A is a rear elevation view of the bracket 40 further illustrating the construction of the bracket 40. The bracket-retention flange 46 is spaced from the pivot member 44 in a radial direction R₁ as defined with respect to the pivot axis 43. The shelf-support flange 48 is spaced in the same radial direction R₁ from the pivot member 42 as the bracket-retention flange 46. The shelf-support flange 48 should generally be spaced at least the same distance in the radial direction R₁ as the bracket-retention flange; in this embodiment, the shelf-support flange 48 is spaced a distance D₂ from the pivot axis 43 that is greater than the distance D₁ that the bracket-retention flange 46 is spaced from the pivot axis 43. The shelf-support tab 50 projects radially inward (with respect to the pivot axis 43) of the shelf-support flange 48. The bracket-retention flange 46 and shelf-support flange 48 project from the body of the bracket 40 in opposing directions T₁, T₂, which generally should be transverse to the radial direction R₁, and in this embodiment are perpendicular to the radial direction R₁. The purpose of these features and their positioning is further detailed below. However, the reference to a radial direction is a term generally applicable to the bracket in either a horizontal, unlocked position (See FIG. 4A; where the radial direction is horizontal) or a vertical, locked position (See FIG. 4C; where the radial direction is vertical).

The bracket 40, or a substantial portion thereof, may be formed as a unitary structure from a single piece of material. For example, the pivot arm 42, bracket-retention flange 46, shelf-support flange 48, and shelf-support tab 50 may all be formed from a single piece of sheet metal using sheet-metal forming techniques such as by cutting a portion of the bracket body 41, then folding the sheet metal to form the bracket-retention flange 46 and shelf-support flange 48. Desirably, forming the bracket 40 or a substantial portion thereof as a unitary structure reduces part count and can increase the strength and durability of the bracket 40.

FIG. 3B is a front elevation view of the bracket 40 with the shelf 30 supported on the shelf-support tab 50 and with a piece of equipment 70 supported on the shelf 30. The piece of equipment 70 may be, for example, a server or a server chassis. A “locking member” 51 is optionally included and hooks under the shelf-support tab 50 to slidingly secure the shelf 30 to the bracket 40. The shelf-support tab 50 provides a contact surface 52 for supporting a corner 31 of the shelf 30.

FIGS. 4A, 4B, and 4C sequentially illustrate the bracket 40 being removably secured to one of the vertical supports 20. FIG. 4A is a perspective view of the bracket 40 in a first angular position about the pivot axis 43, alternately referred to as an “unlocked position,” prior to securing the bracket 40 to the vertical support 20. The vertical support has a generally L-shaped cross-section, as defined by first and second vertically-projecting rails 21, 22 joined at an angle. In this embodiment, the rails 21, 22 are at a right angle (about ninety degrees). The first rail 21 has a plurality of vertically spaced holes 23. The cylindrical pivot member 44 is aligned for insertion into a selected one of the holes 23A in the first rail 21. An arrow indicates a direction of translation of the bracket 40 for moving the pivot member 44 into the selected hole 23A.

In the “unlocked position” of FIG. 4A, the bracket body 41 extends laterally away from the vertically projecting rail 21, such that the pivot member 44 may be inserted into the hole 23A without interference between the bracket-retention flange 46 and the rail 21. In particular, the bracket dimension D₁ (the distance between the axis 43 of pivot member 44 and the bracket-retention flange 46) is greater than the rail dimension X₁ (the distance between the axis of the hole 23A and the edge of the rail 21).

FIG. 4B is a perspective view of the bracket 40 having been translated in the direction of the arrow of FIG. 4A to insert the pivot member 44 into the selected hole 23A and so the pivot arm 42 abuts the first rail 21. In the unlocked position, the pivot member 44 is easily inserted into the selected hole 23A, with clearance between the bracket-retention flange 46 (see FIG. 4A) and the first rail 21. While connected to the vertical support 20 in the first angular position, as shown, the bracket 40 may be described as being “rotated upwards.”

FIG. 4C is a perspective view of the bracket 40 being pivoted clockwise about the pivot 43, from the unlocked position to a second angular position, alternately referred to as the “locked position,” to releasably secure or “lock” the bracket 40 to the vertical support 20. When performed by hand by a user, this motion may be referred to as “rotating” the bracket 40 to the locked position. A phantom line type represents the bracket 40 in the unlocked position of FIG. 4B; a solid line type represents the bracket 40 in the locked position. Due to the geometry of the bracket 40 and the location of the pivot member 44, gravity biases the bracket 40 from the unlocked position toward the locked position. In the locked position, the bracket-retention flange 46 has now moved behind the first rail 21, to secure the bracket to the vertical support with the first rail received between the pivot arm 40 and the bracket-retention flange 46, which prevents translation of the bracket 40 in the direction opposite the direction depicted in FIG. 4A, and, hence, prevents removal of the bracket 40. Optionally, the width of the bracket-retention flange is substantially equal to the width of the rail 21 so that an outer edge 47 of the bracket-retention flange 46 abuts an inner surface 27 of the second rail 22 when the shelf-support flange 48 is horizontal. This configuration provides stability to and increase the load-bearing capacity of the bracket 40. The weight of rack-mount equipment supported on the bracket 40 imparts a moment to the bracket 40 about the pivot member 44 that urges the bracket 40 toward and retains the bracket 40 in the downward, locked position, and urges the outer edge 47 of the bracket-retention flange against the inner surface 27. The bracket-retention flange 46 optionally projects laterally beyond an outer edge 26 of the second rail 22, which extra length allows the bracket 40 to be used on different sizes of vertical supports.

In the locked position of the bracket 40, the opening 45 is aligned with another one of the holes 23B in the first rail 21 below the hole 23A into which the pivot member 44 is inserted. A fastener 54 may then be inserted into the hole 23B, along the direction indicated. The fastener 54 may be, for example, a pin or a threaded fastener, such as a screw or a bolt. Once inserted into the hole 23B, the fastener 54 further secures the bracket 40 in the locked position, preventing upward movement of the bracket 40. Although use of the fastener 54 is generally not required once shelves and other loads are supported on the bracket 40, the fastener 54 provides additional security for the bracket 40 in the case that the rack assembly may be shipped in an assembled or partially-assembled condition. For example, the vertical supports 20 may be shipped with the brackets 40 secured to the vertical supports 40, and the fasteners 54 will keep the bracket 40 in the locked position to prevent the bracket 40 from coming off during transport.

As shown in and described with reference to FIGS. 4A-4C, the bracket 40 may be secured to the vertical support 20 using a simple “insert and rotate” motion. That is, in the progression of FIG. 4A-4B, a user may first insert the pivot member 44 into the selected hole 23A in the vertical support 20. Then, the user may rotate the bracket 40 to lock the bracket 40 to the vertical support 20, as shown in and described with reference to the progression of FIG. 4B-4C. This aspect of the invention in the embodiments presented herein allow the user to quickly and easily support shelves 30 or other support structures (such as rack-mount chassis) in a rack.

FIG. 4D is a perspective view of the bracket 40 in a locked position shown from the opposite side from FIG. 4C. The pivot member 44 is fully inserted into the hole 23A, but cannot be pulled out of the hole 23A with the bracket in the locked position as shown. In particular, the gap 53 between the pivot arm 42 and the retention bracket 46 has a width has a width Y₁ that is slightly greater than the thickness of the vertical rail 21 so that the rail 21 is received or captured therebetween when the bracket 40 is in the locked position. Because the weight of the shelf or other component pushes downward on the shelf-support flange 48 and/or tab 50, the bracket 40 is secured unless the weight is removed and the bracket 40 is rotated upward to the unlocked position shown in FIG. 4B.

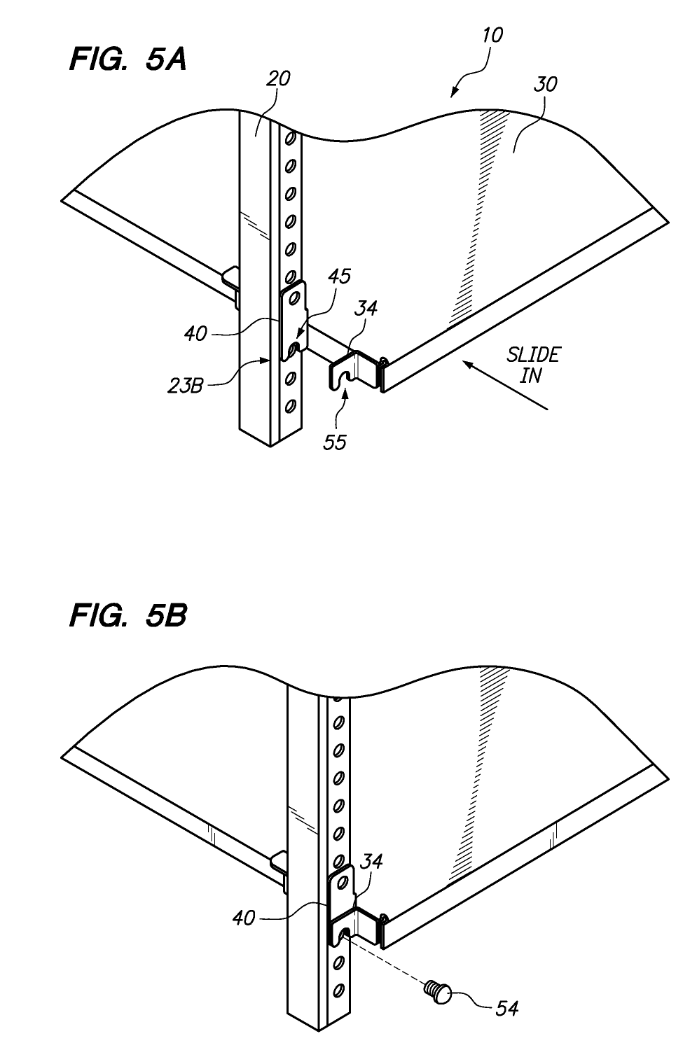

FIGS. 5A and 5B sequentially illustrate the shelf 30 being assembled to the rack 10. FIG. 5A is a perspective view of the shelf 30 being lowered onto the previously installed mounting brackets 40. For ease of illustration, only one vertical support 20 and one bracket 40 are shown, for supporting one corner 31 of the shelf 30, but one skilled in the art will understand that other corners of the shelf 30 may be similarly supported on additional vertical supports using other brackets. The corner 31 of the shelf 30 sits on top of the shelf-support tab 50, with the weight of the shelf 30 supported by the shelf-support flange 48 (refer to FIG. 2 for features of the bracket 40). A shelf-securing flange 34 projects from the shelf 30, with an opening 55 aligned with the opening 45 in the bracket 40 and the hole 23B in the vertical support 20. In FIG. 5A, the shelf 30 is still slightly forward of its final installed position. Though the shelf 30 is shown supported on the brackets 40 in this example, one skilled in the art having the benefit of this disclosure will appreciate that a rack-mount chassis capable of holding one or more rack-mount components may be similarly supported on the brackets 40, either on the shelf 30 or directly on the brackets 40.

FIG. 5B is a perspective view of the shelf 30 having been slid in the direction indicated in FIG. 5A until the shelf-securing flange 34 abuts the bracket 40. The optional fastener 54 (refer also to discussion of FIG. 4C) may be inserted through the aligned opening 55 in the shelf-securing flange 34, the opening 45 in the bracket 40, and the hole 23B in the vertical support 20, to secure the shelf 30 and bracket 40 to the vertical support 20. The fastener 54 may be used to secure the entire assembly of vertical supports 20, brackets 40, and shelves 30, for shipping the entire rack 10.

Installing the shelf 30 locks the brackets 40 in place. The presence of the installed shelf 30 prevents the brackets 40 from rotating out of the locked position, thereby preventing the brackets 40 from detaching from the rack 10. To prevent the shelf from sliding out inadvertently, simple spring latches may also be included with the shelf 30. When the shelf 30 is fully inserted onto the support brackets 40, the spring latches “pop-out” and prevent the shelf 30 from being pulled back out without pressing the latches. Spring latches such as this are only one possible way of insuring the shelf is not inadvertently removed.

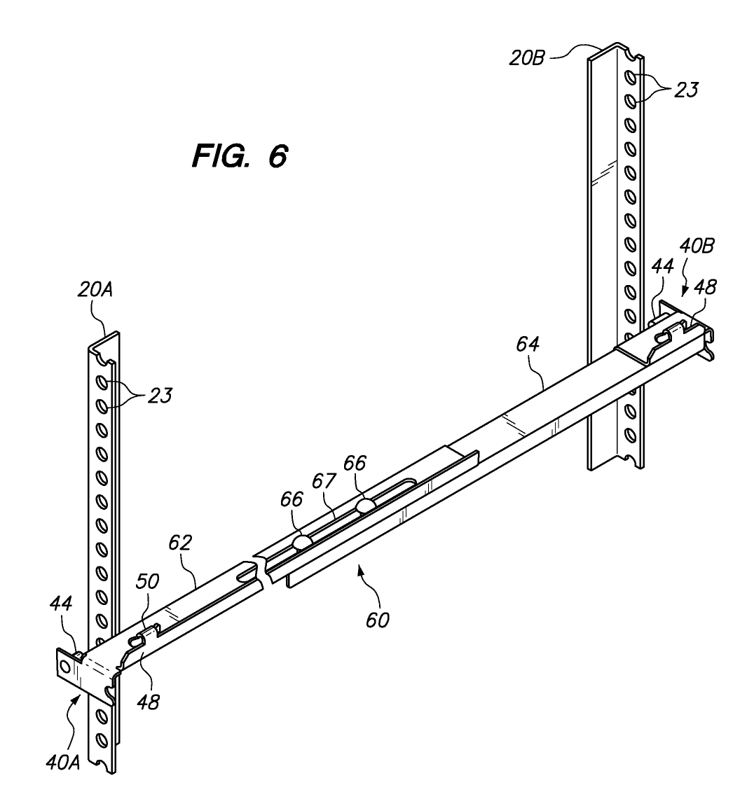

FIG. 6 is a perspective view of another example embodiment of the invention wherein brackets 40A, 40B are provided at the ends of an adjustable-length “telescoping” horizontal support beam 60. The horizontal support beam 60 includes a first beam member 62 slidingly coupled to a second beam member 64, such as with pins 66 on one member riding in a slot 67 on the other member. The overall length of the horizontal support beam 60 is user-adjustable by sliding the first beam member 62 with respect to the second beam member 64. Other manners of slidingly coupling the first and second beam members 62, 64 are equally within the scope of the invention.

The first bracket 40A is attached or integrated with the first beam member 62 and the second bracket 40B is attached or integrated with the second beam member 64. The brackets 40A, 40B may be integrated with the horizontal support beam 60 or attached to the ends of the horizontal support beam 60 by welding or brazing, using hardware, or by other structural joining methods known generally in the art. The brackets 40A, 40B are the same as or similar to the bracket 40 detailed in FIG. 2, except that the bracket 40B is a mirror image of the bracket 40A. Thus, the brackets 40A, 40B may be removably secured to oppositely-oriented vertical supports 20A, 20B in the manner described above with respect to a single bracket 40 and vertical support 20. Features of the brackets 40A, 40B are assigned the same reference numerals as features of the bracket 40.

In FIG. 6, the horizontal support beam 60 is shown positioned with the brackets 40A, 40B in the unlocked position. The pivot members 44 are aligned for insertion into respective holes 23 in the vertical supports 20A, 20B. The horizontal support beam 60 is horizontally level so that the pivot members 44 are aligned with holes 23 at about the same height. The first and second beam members 62, 64 may be slid toward each other to move the pivot members 44 of the brackets 40A, 40B into the respective holes 23 in the vertical supports 20A, 20B, as described above with respect to the sequence of FIG. 4A to FIG. 4B. Then, the entire horizontal support beam 60, along with the included brackets 40A, 40B, may be rotated downwards to lock the brackets 40A, 40B to the vertical supports 20A, 20B, as described above with respect to FIG. 4C.

Another horizontal support beam (not shown) may be secured to two vertical supports adjacent to the two vertical supports 20A, 20B, to construct a rack similar to the rack of FIG. 1. Horizontal support beams may be similarly positioned at other vertical levels of the rack. The horizontal support beam 60 provides additional lateral support to the vertical supports 20A, 20B. Although not required, the horizontal support beam 60 may also provide load-bearing support for the shelf 30, supported, as described above, on the brackets 40A, 40B. The shelf-support flange 48 on the first bracket 40A has an extended length along the first beam member 62. Although the weight of the shelf or chassis may be supported primarily on the shelf-support tabs 50, some of the weight of the rack-mount components may be distributed along the extended length of the shelf-support flange 48. Although not shown, the shelf-support flange 48 on the other bracket 40B may be similarly extended.

One skilled in the art will appreciate that other horizontal support beam configurations may be constructed having end-brackets 40 as described above. For example, in an alternative embodiment (not shown), a fixed-length horizontal support beam may be provided with a bracket at each end. In such an embodiment, because the horizontal support beam has a fixed length, the vertical supports could instead be manipulated so that selected holes in the vertical supports receive pivot members of the end brackets. Alternatively, the bracket 40 (as described above) could be provided at just one end of the fixed-length horizontal support beam, for locking the bracket 40 to one vertical support, and the other end of the horizontal support beam could have a simple pin for inserting into a corresponding hole at the same level on another vertical support.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A rack assembly, comprising:
a plurality of vertical rack supports each having a first rail and a second rail joined at an angle, the first rail defining a plurality of vertically-spaced holes having a central axis positioned a first distance from an edge of the first rail;
a bracket for each vertical support, each bracket including a bracket body, a pivot arm projecting to a first side of the bracket body, a pivot member coupled to the pivot arm and having a pivot axis orthogonal to the pivot arm, a bracket-retention flange projecting to the first side of the bracket body and radially spaced from the pivot member, and a shelf-support flange projecting to a second side of the bracket body and spaced in the same radial direction from the pivot member; and
wherein a second distance between the pivot axis of pivot member and the bracket-retention flange is greater than the first distance such that the pivot member of the bracket is removably insertable into one of the vertically-spaced holes with the bracket in a first angular position, and wherein the pivot member and the bracket-retention flange are spaced apart such that the bracket is pivotable from the first angular position to a second angular position for receiving the first rail between the pivot arm and the bracket-retention flange.

2. The rack assembly of claim 1, wherein the bracket-retention flange contacts an inside of the second rail when the bracket is in the second angular position.

3. The rack assembly of claim 1, further comprising:
an opening along the pivot-arm and radially spaced from the pivot member in the same radial direction as the bracket-retention flange such that the opening is generally aligned with one of the holes below the pivot member.

4. The rack assembly of claim 3, further comprising:
a fastener insertable through the opening along the pivot arm and the hole aligned with the opening for securing the bracket in the second angular position.

5. The rack assembly of claim 1, further comprising:
a shelf having a corner supportable on the shelf-support flanges of the brackets.

6. The rack assembly of claim 5, further comprising:
a shelf-securing flange projecting from the shelf and having an opening aligned with one of the vertically-spaced holes when the shelf is supported on the brackets.

7. The rack assembly of claim 1, further comprising:
a horizontal support beam with one of the brackets secured to one end of the horizontal support beam and another one of the brackets secured to an opposing end of the horizontal support beam.

8. The rack assembly of claim 7, wherein the horizontal support beam is a variable-length horizontal support beam.

9. The rack assembly of claim 1, wherein the pivot arm, bracket-retention flange, shelf-support flange and the bracket body are a unitary sheet metal structure.

10. The rack assembly of claim 1, wherein the shelf-support flange is spaced further in the radial direction from the pivot member than the bracket-retention flange.

11. The rack assembly of claim 1, wherein the shelf-support tab comprises a locking member for releasably locking the shelf to the bracket.

12. The rack assembly of claim 1, wherein the bracket-retention flange is spaced from pivot arm in a direction parallel to the pivot axis of the pivot member.

13. A rigid mounting bracket, comprising:
a bracket body;
a pivot arm projecting from the bracket body and including a pivot member having a pivot axis orthogonal to the pivot arm;
a bracket-retention flange projecting from the bracket body and spaced in a radial direction from the pivot member; and
a shelf-support flange projecting from the bracket body and spaced in the same radial direction from the pivot member and at least the same distance from the pivot member as the bracket-retention flange, wherein the shelf-support flange and bracket-retention flange project in opposing directions transverse to the radial direction.

14. The mounting bracket of claim 13, wherein the shelf-support flange is spaced further in the radial direction from the pivot member than the bracket-retention flange.

15. The mounting bracket of claim 13, further comprising a shelf-support tab coupled to the shelf-support flange and projecting radially inward of the shelf-support flange.

16. The mounting bracket of claim 13, wherein the shelf-support tab comprises a locking member for releasably locking a shelf.

17. The mounting bracket of claim 13, wherein the bracket-retention flange is spaced from pivot arm in a direction parallel to the pivot axis of the pivot member.

18. The mounting bracket of claim 13, further comprising an opening defined by the pivot-arm and radially spaced from the pivot member in the same radial direction as the bracket-retention flange.

19. A method of assembling a rack, comprising:
selecting one of a plurality of vertically-spaced holes in a first rail of a vertical support;
orienting a bracket in a first angular position relative to the first rail so that a pivot arm of the bracket has a pivot member axially aligned with the selected hole and there is clearance between a bracket-retention flange of the bracket and the first rail of the vertical support;
removably inserting the pivot member into the selected hole until the bracket retention flange is positioned on a side of the first rail that is opposite the pivot flange; and
pivoting the bracket about a pivot axis of the pivot member to a second angular position so that the first rail is received between the pivot arm and the bracket-retention flange.
